(19) United States
(12) Patent Application Publication
(10) Pub. No.: US 2010/0140277 A1
(43) Pub. Date: Jun. 10, 2010

(54) PRE-LOADING

(76) Inventors: Martin Clive-Smith, Warwickshire (GB); Herbert Kong, Shenzhen (CN)

Correspondence Address: Law Offices of Donald N. Macintosh, 275 Battery Street, Suite 200, San Francisco, CA, 94111, US

(21) Appl. No.: 12/449,860

(22) PCT Filed: Mar. 3, 2008
(86) PCT No.: PCT/GB2008/051140

§ 371 Date: Feb. 19, 2010

(30) Foreign Application Priority Data
Mar. 2, 2007 (CN) 200710073435.9

(51) Int. Cl. B65D 8/04; B23P 11/02

(52) U.S. Cl. 220/600; 29/446

(57) ABSTRACT

Computer apparatus for use with a database management system and database, the apparatus comprising a CPU and a memory, the apparatus configured to provide at least two task processes each process being apportioned a section of the memory when is use, wherein in response to the database management system or apparatus being instructed to carry out a first task, such as reading, and a second task, such as decryption, on a section of data in series, a first task process is configured to begin the first task on a first part of the section of data in the database and (after a the first process on the first part of the section of the data is complete); a second task process is instructed to carry out the first task on a second part of the section of data which begins where the first part ends, and when the first task is complete and the first task process switched to carry out the second task on data on which the first task has already been carried out, or the second process is instructed to carry out the second task on the first part whilst the first process switches to carry out the first task on the second part of the data, or the second task process is instructed to carry out the first task on a second part of the section of data the first task process is switched to pipeline the second task to a third task process.

### BACKGROUND—PRIOR ART

The Applicant has previously devised pre-loading for pre-stressing of individual beams or elements for subsequent assembly in a pre-fabricated lattice frame. A particular use is in the manufacture of flat bed containers or so-called ‘flat racks’ in which a deck features an array of interconnected beams and elements. Generally, longitudinal beams on opposite deck sides are bridged by transverse beams.

Decks are subject to considerable passive or dead weight cargo loads and operational handling and stacking loads so are susceptible to flex and permanent bending set, which taken to extremes can lead to misalignment in handing and stacking fittings.

The rationale of pre-loading is to create a counter-set or curvature which is taken up when the container is put into active service.

Such beam pre-loading is selectively applied at strategic locations along beam length. Pre-calculated forces are applied locally at a series of target locations for a certain time period to deform the beam by a prescribed amount. The force applied locally and collectively is sufficient for local bending to achieve a ‘permanent’ memory or ‘set’. This is offset upon working loading of the pre-stressed beam in operational use.

Pre-loading has implications not only for the element itself, but for interfaces, (rigid) connections, or joints with other elements. ‘Live’ working stresses are accommodated by relieving and/or re-distributing some or all of the ‘stored’ pre-loading stress.

### Assembly Pre-Loading

Wholesale composite or synchronised loading of a complete interconnected frame assembly in its entirety, as a ‘containment boundary’, but applied over multiple distributed contact points, has also been proposed, but stress distribution is constrained in less predictable ways with less predictable consequences.

Thus conventional frame element interconnections are primarily intended and designed at the outset to achieve a desired frame configuration or layout and combined operational rigidity, rather than to address transfer of pre-loading stresses to preface operational use.

Pre-loading has hitherto been used in the context of the extremes of container pre-fabrication, that is individual elements and completed frame assemblies. In contrast the present invention envisages intermediate frame sub-assemblies of part-completed frames. This poses unique problems not previously addressed. Thus the effect of pre-loading sub-assemblies per se and assembling and possible further pre-loading of multiple sub-assemblies into a complete final assembly. Further loading risks undermining the effect of previous pre-loading, with unpredictable outcomes.

### STATEMENT(S) OF INVENTION

The present invention applies pre-loading to a sub-frame, preparatory to sub-frame assembly with other (pre-loaded or unloaded) elements or sub-frames into larger sub-assemblies, culminating with a full or completed frame assembly, along with junctions, links, transitions or joints between elements and/or sub-assemblies, such as flanges or hinges, between elements.

As to what constitutes a sub-assembly is otherwise moot, but the intention is sub-assemblies to which further elements or sub-assemblies are to be secured.

Staging, staggering or phasing pre-stressing from or beyond individual elements, through intermediate combinations of elements, allows greater control over both the application of pre-stressing loads and the internal accumulated stress effect. Intermediate checks can be made and further correction applied preparatory to continuing assembly.

Elements may be joined before, during or after sub-assembly. In an assembly, locally applied stresses are distributed between and among elements. A prime pre-stressing mode is over the longitudinal span of an elongate beam, between opposite beam ends, with intermediate support and/or bracing. Loading is applied at one or more locations along the beam, typically by individual loading jacks. A splayed, multi-head, bifurcated or offset jack end fitting can be employed to distribute applied pre-load stress to spaced points.

### STATEMENT OF INVENTION (2)

A method of pre-loading a sub-frame, preparatory to sub-frame assembly with other pre-loaded or unloaded elements or sub-frames into larger sub-assemblies, culminating with a full or completed frame assembly, along with junctions, links, transitions or joints between elements and/or sub-assemblies, such as flanges or hinges, between elements whereby to introduce and/or retain internal stresses better to accommodate and counter operational loading stress arising.

A sub-frame pre-loaded by the method.

A pre-fabricated container incorporating a pre-loaded sub-frame.

A collapsible flat-rack configuration container with a platform deck chassis support structure and/or folding end walls pre-loaded by the method.

A method of manufacturing flatrack base, comprising the following steps:
(a) Fabricate bottom side rails with upward camber.
(b) Fix cross members transversely between two bottom side rails related in step (a) to form a original flatrack base.
(c) Install corner castings on the original flatrack base related in step (b) according to different types of flatracks.
(d) Place the flatrack base related in step (c) on work beds at four corners, and depress the flatrack base by plural cylinders which distributed by the center of bottom side rails on different points.

The method of manufacturing flatrack base, wherein the step (c) comprising: firstly weld the corner castings at the bottom of fixed hinge plate, then weld the welded corner castings and fixed hinge plate to the two ends of the sill respectively, finally weld the union of the said three parts to the two ends of the bottom side rails of the original flatrack base.

The method of manufacturing flatrack base, wherein the step (c) comprising: weld the corner castings at the bottom of fixed hinge plate, then directly weld the union of welded fixed hinge plate and corner castings at the two sides of the ends of the original flatrack base.

The method of manufacturing flatrack base, wherein the base is jacked up at the middle of two longitudinal sides of the flatrack base before implementing the said step (d).

The method of manufacturing flatrack base, wherein the said flatrack base is jacked up to make the camber be a 3 mm-5 mm permanent deflection upwards.

The method of manufacturing flatrack base, wherein the said bottom side rails are welded rails, comprising top flange, bottom flange and at least one web which is between the top flange and bottom flange, and the web is an arch with camber.

The method of manufacturing flatrack base, wherein when the said welded rails are shaped, firstly depress or jack up the top flange and bottom flange to an arched plate which conforms with the camber of web, then separately weld the top flange, bottom flange with the top and bottom of web, so the welded bottom side rails have a certain camber.

The method of manufacturing flatrack base, wherein the camber of the web for 40 ft flatrack is 50 mm-80 mm, while the camber of the web for 20 ft flatrack is 15 mm-45 mm.

The method of manufacturing flatrack base, wherein depressing the flatrack base on different points in step (d) is finished by several times, the camber of shaped base for 40 ft flatrack is 40 mm-65 mm, while the camber of shaped base for 20 ft flatrack is 10 mm-30 mm.

The method of manufacturing flatrack base, wherein the said bottom side rails are hot rolled beams and cambered upwards previously so that the bottom side rails have an upward camber.

The method of manufacturing flatrack base, wherein the camber of the bottom side rails for 40 ft flatrack is 50 mm-80 mm, while the camber of the bottom side rails for 20 ft flatrack is 15 mm-45 mm.

The method of manufacturing flatrack base, wherein depressing the base on different points in step (d) is finished by several times, the camber of shaped base for 40 ft flatrack is 40 mm-65 mm, while the camber of shaped base for 20 ft flatrack is 10 mm-30 mm.

### Layered Frame Assembly

A stacked, layered or tiered frame assembly can be loaded together as a unitary (cohesive) group, with forces applied to or between outermost frames. Intermediate frame sub-assemblies, such as a peripheral outer bounding frame, can be loaded as an entity.

Similarly, even more basic or ‘primitive’ frame elements can be loaded individually; such as longitudinal and transverse beams, before joining in a peripheral sub-frame assembly. Intermediate transverse rib or spar in-fill can be loaded individually before fitting within, and joining to, a bounding peripheral sub-frame. Application of local force is distributed throughout the structure. Internal stresses are thus both introduced and adjusted to a new (temporary) medium.

A slight (initial) profile curvature or bow can be introduced by pre-loading. This can settle or flatten out under active working loads in use. The attendant profile change can be used to advantage to achieve a long term desired form; such as a straighter or more rectilinear form, rather than one with a sag or deformation curvature.

### Distributed Loading

Distributed multi(ple)-point (contact) loading can collectively and cumulatively create a desired loading pattern and thus in turn a derivative internal stress or stress (re-) distribution and stored energy. This can be adjusted or relieved by loading subsequently applied in active use.

### Connectors, Junctions or Joints

Prospective junctions with other elements or sub-assemblies can be fitted and subject to pre-load, particularly if they or some part of them link elements within that sub-assembly. As overall strength of a completed assembly is contingent upon that of the weakest part, or the weakest joint, the contribution of that pre-loaded joint is material. A common such joint, coupling or connector is configured as a flat plate.

For flanged members, loading is conveniently applied to flange faces which present an accessible contact surface. That, said other webs or web faces can be used. In the case of common I-beam structural members, only an accessible, say, top flange need be directly loaded.

### Incremental Loading

A progressive continuous or incremental (stepped) pre-load can be implemented with frame assembly from individual beam elements through to a lattice grid. Successive step loads might be interspersed with ‘rest’ periods to allow internal stress adjustment.

The pattern or profile of applied loading vs time affects accumulated internal stress. Similarly, the distribution of applied stress affects accumulated re-distribution of internal stress.

### Deflection Containment

The profile of a stressed member sets a deflection ‘containment or curtailment boundary’ for internal stress, with any interconnected member representing a supplementary external local constraint or diversion routing path.

Thus, as compared with, say, a stand-alone beam pre-stressed as with the Applicant's original formative work, a multi-element or composite beam has somewhat modified ‘freedom’ at each point of connection to another frame member.

Overall deflection may differ from an ‘unencumbered’ or stand-alone beam. If the connecting frame is orientated with a component opposed to the load and feeds to a support point, it can provide a bracing to deflection.

There is also the opportunity of applying stress loading through and/or between interconnected members. A connector could thus be used as a route to apply loads to elements to be assembled together.

### Closed vs Open Frame

An open frame may leave ‘unresolved’ elements or limbs free at one (outboard) end, which may not lend themselves readily to pre-loading or rather retention of pre-loads. With a ‘closed’ or bounded frame assembly, with no such ‘loose’ ends, greater opportunity for mutual bracing and restraint may arise.

A lattice beam is a common cost-effective wholly or partially ‘closed’ configuration for bolstering beam section bending stiffness without undue weight penalty compared to a solid beam. A peripheral or bounding portion is braced by in-fill.

Non-rectangular lattice formats, such as diagonal criss-cross intersection lattice intersection, and/or curved (say, oval or circular) peripheral bounding frames, can be pre-loaded.

### Frame Element Interconnection

The mode of interconnection has a bearing upon load transfer. In particular any bracing, such as a gusset or flange helps resist relative bending and thus contributes to stiffness of the assembly. On the other hand, say, a pin jointed connection allows or accommodates relative movement of elements and thus overall assembly flexing, whilst bolstering strength and fatigue resistance.

A combination of elongate struts and plates could be contrived for greater sophistication in stiffness and strength, Plates could themselves be complex forms, such as multi-layer, sandwich or hollow fabricated or extruded forms.

The relative orientation of interconnected elements, for example co-planar or mutually orthogonal, allows local adjustment of behaviour.

### Sub-Assembly Interconnection

A similar consideration applies to the relative orientation and interconnection of sub-assemblies. In that regard, two or more elements can be regarded as a sub-assembly. Similarly for two or more sub-assemblies or element and sub-assembly combinations.

Although ‘loading’ jacks mounted externally of the structure are convenient, they may also be mounted ‘within’ the structure, that is installed (albeit temporarily) in between elements or sub-assemblies and subsequently removed.

### Loading Mode or Pattern

A continuous, constant or variable, such as phased intermittent or cyclical repeated (pulsating) loading mode or pattern may be achieved by regulating (say hydraulic) power or energisation charge to loading jacks.

Jacks might also be carried upon adjustable or movable mountings, such as eccentric cams upon a rotary drive shaft as a mechanical means of relative positioning and thus displacement and loading variation. A reciprocating loading could be achieved upon mounting shaft rotation.

Alternatively, or additionally, for relative movement, jacks could be stationary and the subject frames moved or a combination motion performed.

Absolute, or change in, relative disposition of elements upon loading can be used as a ‘raw’ indicator to determine loading or induced stress. FIGS. 19 through 22 sequences lend themselves to this.

### Loading Restraints or Deflection Limits

It might be contrived that certain elements will touch upon a certain pre-loading, for which a visible check can be made by an operator controlling applied load.

Such inter-element contact might also be used as an initial cushion buffer, ultimate deflection travel abutment limit, or as a ‘trigger’ to inhibit jack energisation and further loading. Ongoing loading beyond this might still be countenanced to apply more severe and/or re-directed (say compressive or bending) internal stress.

### Displacement or Buckling

In the case of a plate element, lateral buckling can be used as a visual loading deflection indicator or limit. Thus, say, juxtaposed plates buckled into mutual contact could serve as an initial limit. Loading within or even in certain instances beyond, elastic limit could be utilised.

When elements are displaced, buckled or deformed under pre-loading, some residual resilience may be relied upon in any inter-element contact. This, rather than a sudden rigid contact and abrupt change in load transfer.

The spacing and bending of (restraint or travel limit) elements could be contrived such that progressively and successively more come into contact upon loading—offering an accumulated buffer resistance. The bending profile could be determined by multiple distributed such loading restraints, which effectively act as local limits, say by disposition in co-operative initially spaced pairs which come into contact upon loading deflection of a carrier beam. FIGS. 19 through 21 sequences are examples of this.

A combination of deflectable and rigid or (more) obstructive element relative dispositions could be arranged for such deformation modes. Thus, say, certain elements could be set (mutually) orthogonal to others. A strut, brace, link or tie element could be set orthogonal to a plate element, or different plate elements, ties, props or struts set mutually orthogonal. Ties could be semi-rigid rods or flexible cables with fixed or adjustable end mountings.

### Load Timing & Phased Element Loading

It may well be that in a ‘composite’ structure and attendant complex (pre-)loading pattern, elements are differentially stressed according to their disposition, orientation or loading phase.

That is some elements can take a lead or precedence in absorbing the initial effect of applied loading, with other elements in a peripheral support role. Other elements can take up the (pre-)load only after some initial deflection of ‘lead’ elements. Relative primary and secondary roles can thus be allocated to elements for pre-loading.

Provision may be made to alter the disposition of elements after initial pre-loading. Thus local disconnection and re-connection might be contemplated. This along with selective local admission or removal of elements at intervals in the loading phase and any intervening relaxation or recovery stage.

### Successive Interleaved Pre-Loading and Assembly

The invention embraces part-assembly and pre-loading; with further assembly and pre-loading repeated until a full assembly is achieved, with our without final pre-loading. Thus it is unnecessary to complete an assembly before pre-loading. Rather, part-completed and part pre-loaded frame structures are tenable.

Subsequent assembly and pre-loading can be undertaken at different stages and at remote sites. Part-assembled and pre-loaded material can be held or distributed as stock ready to serve different roles in diverse overall assembly forms.

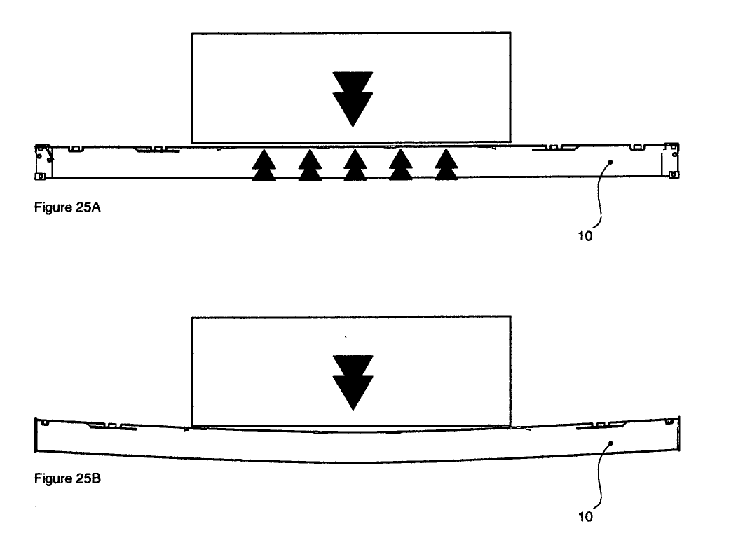

‘Active’ pre-loading by (powered) jacks aside, ‘passive’ pre-loading can be contrived by using the inherent mass or weight of a structure. Similarly, temporary cargo load can contribute to pre-loading simply by appropriate local mounting support or capture, such as stacking, hanging or cantilever action. FIGS. 25A and 25B depict this.

Such ‘passive’ loading can be adjusted by interconnecting elements, so some elements carry some part of the passive weight load of others. Overall, elements could carry the entirety of their own weight, some part or all of the weight of other elements, or be relieved of some part of their own weight.

The relative passive and active pre-loads can be adjusted by jacking and/or propping between elements and support structures or jigs and between elements themselves.

Retention elements can be attached to a frame assembly after pre-loading in order to capture or retain internal stress from pre-loading either in whole or in part. Such retention elements could include cables or stays under tension.

Whatever the mode of pre-loading, the active working loads to which a frame assembly is subjected in operational use can act at least partially to relieve stress previously induced by pre-loading. Or put another way, pre-loading can offset, counter or ameliorate the effect of working loads.

Thus deflections or profile changes or departures, such as curvature or bow, from a straight or linear orientation, which would otherwise be associated with or arise from working loads are countered by opposite deflections associated with or arising from pre-loading.

This in turn allows straighter or more rectilinear framework profiles or profiles more consistent with a target profile, such as a flatter format or one without undue sagging deflection or deformation under working loads.

A contribution to stiffness can be achieved by mounting frame assemblies in mutually orthogonal juxtaposition and to which the frame assembly pre-loading technique of the present invention can be applied.

Thus longitudinal and/or transverse frame up-stands can be mounted upon, alongside and/or beneath a deck frame to bolster deck loading capability.

### (SUPPORTING) EMBODIMENTS

There now follows a description of some particular embodiments of the invention, by way of example only, with reference to the accompanying diagrammatic and schematic drawings, in which:

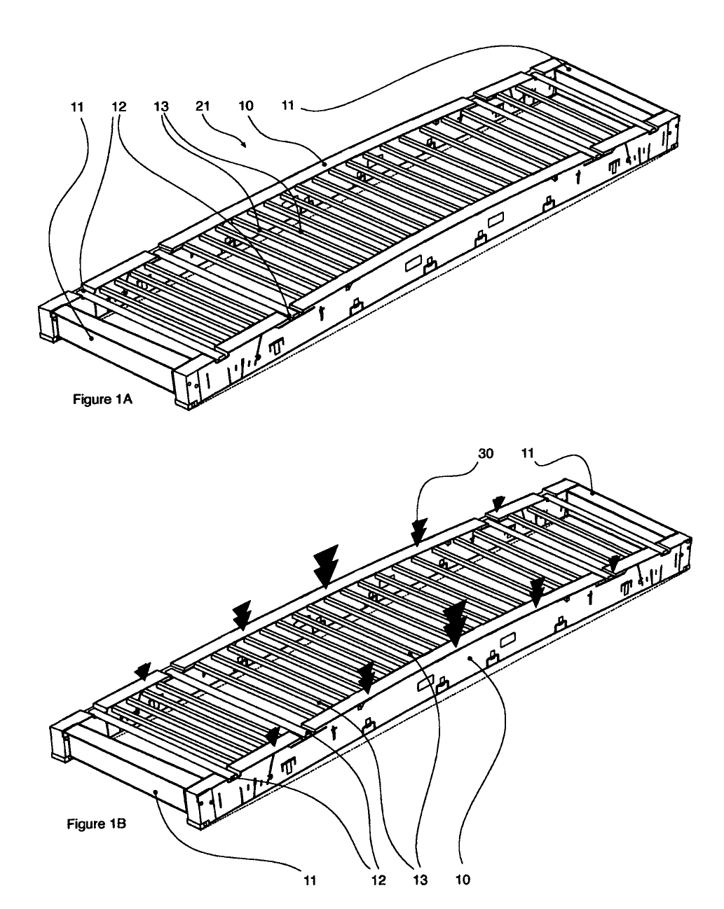

FIG. 1A shows a space-frame assembly of opposed longitudinal beams with intervening transverse strut bracing intermediate the longitudinal span. The assembly has a modest longitudinal curvature ‘set’ or adopts a slightly bowed profile; emphasised visually by reference to a straight broken reference line; that is the actual departure may be exaggerated over reality;

FIG. 1B shows a frame assembly of FIG. 1A, undergoing local point pre-stressing at intervals along the longitudinal beams, at points indicated by solid in-fill arrows; again these are merely indicative, rather than necessarily literal or actual positions, similarly with the applied force level which may be uniform or varied over length; similarly, loads can be relatively phased in timing and strength;

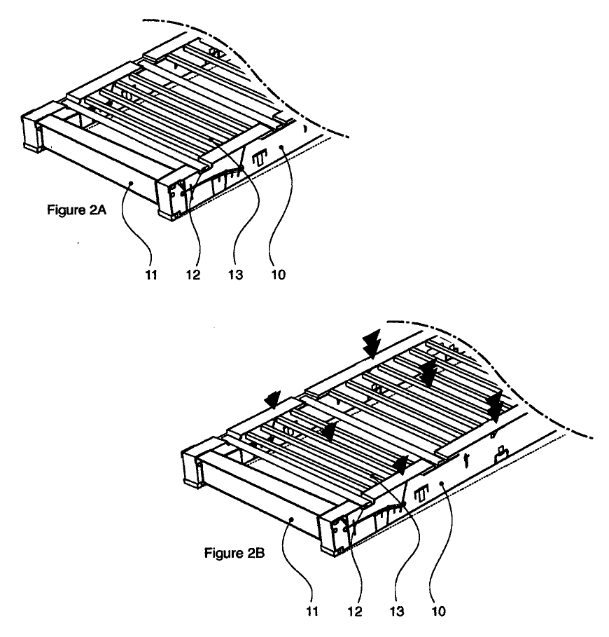

FIG. 2A shows a frame assembly, as a at FIG. 1A, but adapted, by installation of side leaf spring control cushions or dampers, for hinged end walls at opposite deck ends;

FIG. 2B shows a frame assembly of FIG. 2A, undergoing pre-stressing at intervals along the longitudinal beams; the intervals can be varied according to frame

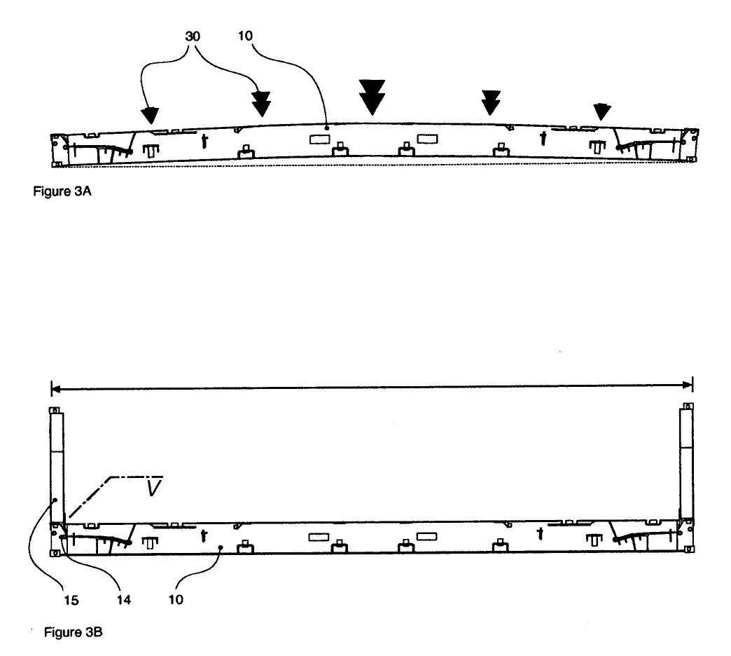

FIG. 3A shows a side elevation view of a frame assembly of FIG. 2B with opposite end walls collapse in-folded within the frame depth about hinge assemblies at each beam end;

FIG. 3B shows a frame assembly of 3A settled flat after pre-loading and with opposite end walls folded out to an upright disposition.

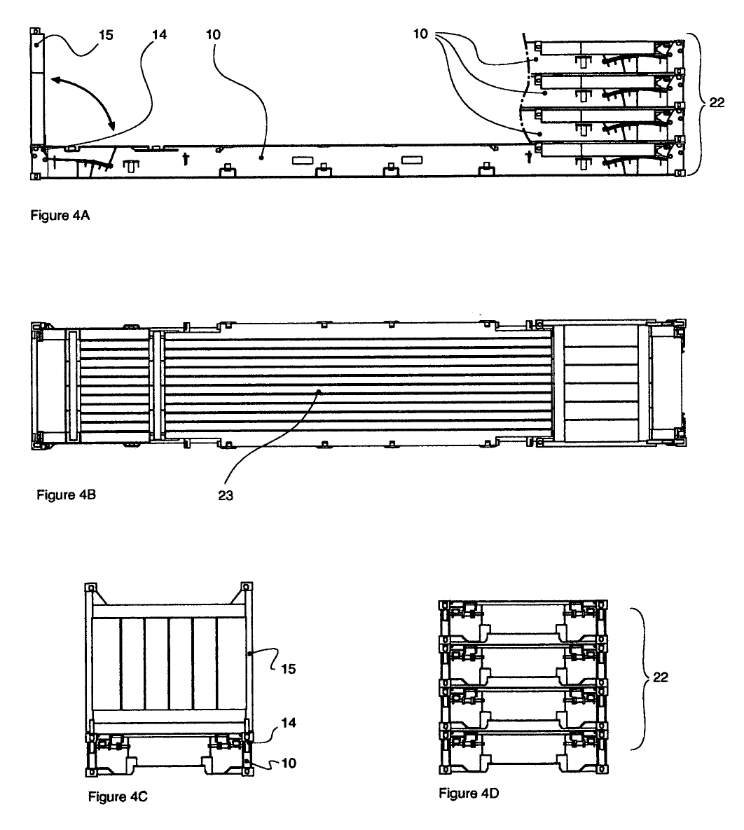

FIG. 4A shows a composite side elevation, depicting an individual deck frame and end frame stood upright at one end and stacked deck frames with respective end frames in-folded at the opposite end;

FIG. 4B shows a plan view of an individual flat-rack in the stack of FIG. 4A, with end wall in-folded over a base deck;

FIG. 4C shows an end view of an individual flat rack of FIG. 4A with end wall out-folded to stand upright;

FIG. 4D shows an end view of stacked fiat racks of one end of FIG. 4A with in-folded end walls;

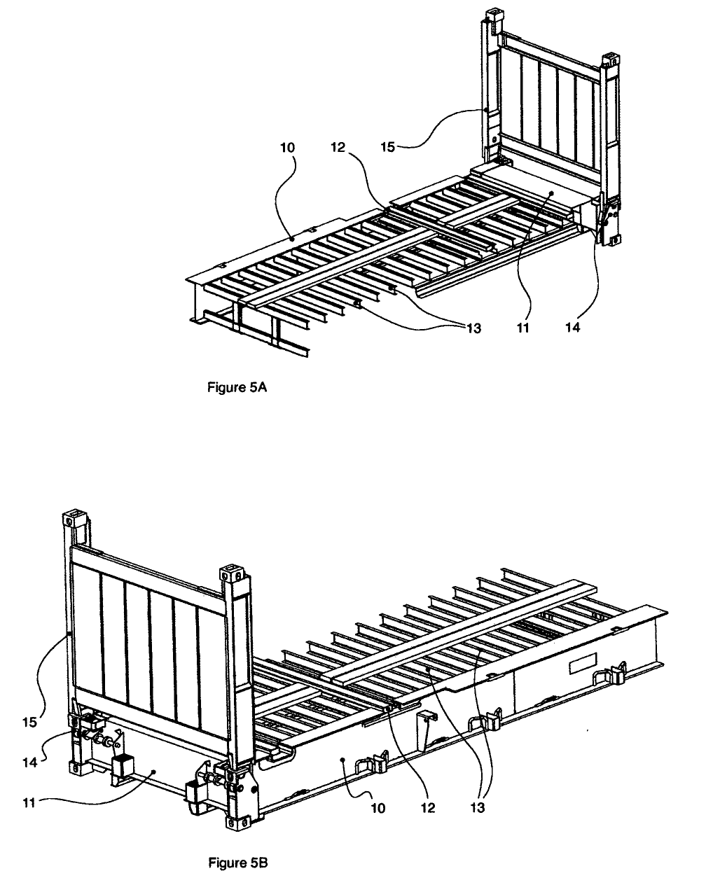

FIG. 5A shows a part cut-away 3D depiction of the lattice or open space frame deck and folding end wall flat rack assembly of FIGS. 3A and 3B;

FIG. 5B shows a part cut-away 3D depiction of the other end of the frame of FIG. 3B to that of FIG. 5A, so collectively FIGS. 5A and 5B reflect a completed deck frame for a flat rack;

FIG. 6A shows an upper three-quarter perspective view of a peripheral deck frame for a flat rack, under pre-load to adopt an initial curvature or set;

FIG. 6B shows a side elevation of the frame assembly of FIG. 6A;

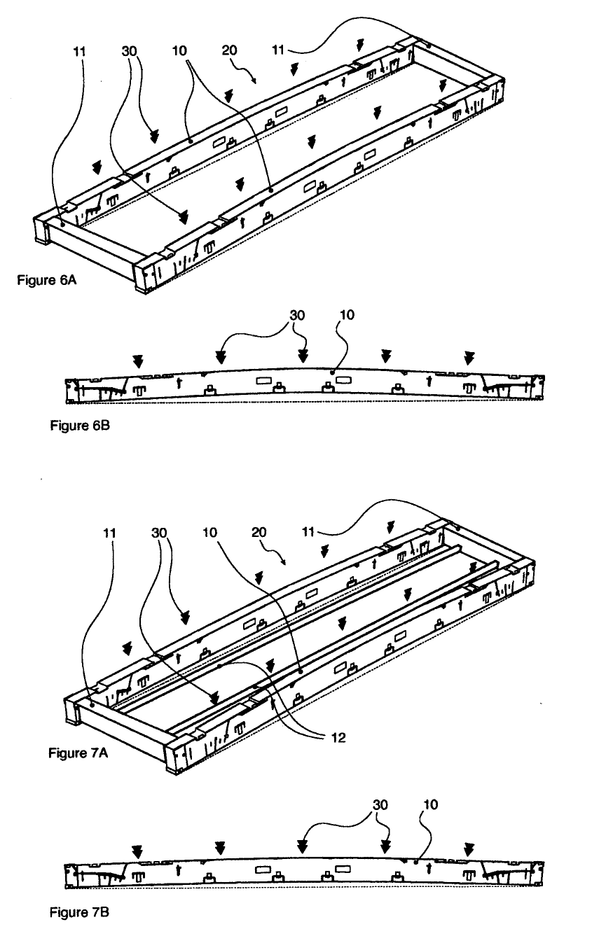

FIG. 7A shows a view corresponding to FIG. 6A, but with longitudinal stringers set within a peripheral deck frame;

FIG. 7B shows a side elevation of the deck frame of FIG. 7A;

FIG. 8A shows a stack of frame assemblies undergoing pre-loading applied along the top assembly.

FIG. 7B shows a stack of frame assemblies undergoing pre-loading from both above and below the stack.

FIG. 8A shows a side elevation of a stack of deck frames undergoing pre-loading from the uppermost frame;

FIG. 8B shows a side elevation of the deck frame stack of FIG. 8A undergoing pre-loading from both above and below the stack;

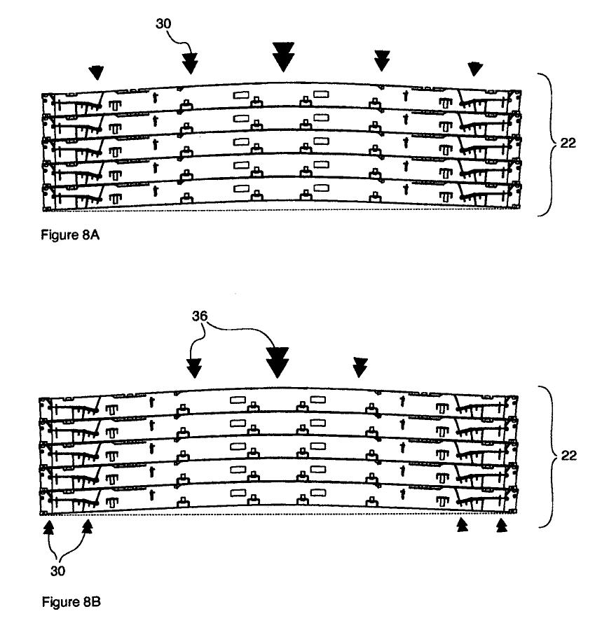

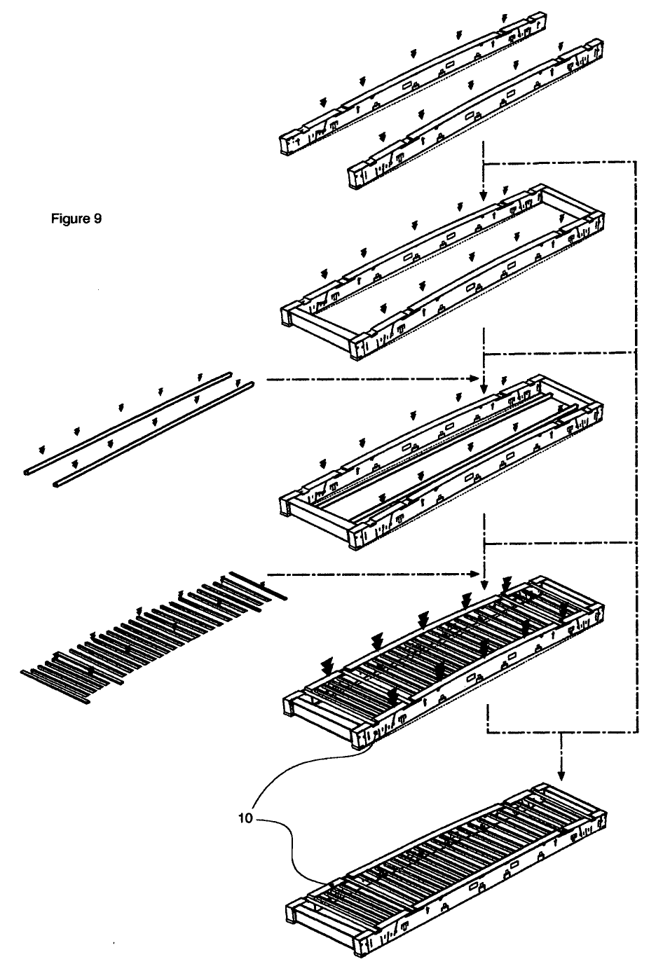

FIG. 9 shows a co-ordinated frame assembly and pre-loading sequence, starting with spaced longitudinal deck beams and culminating in frame assembly with transverse bridging in-fill beams;

FIGS. 10A through 10C depict frame loading upon a setting rig with an elongate support bed carriage for movable loading jacks;

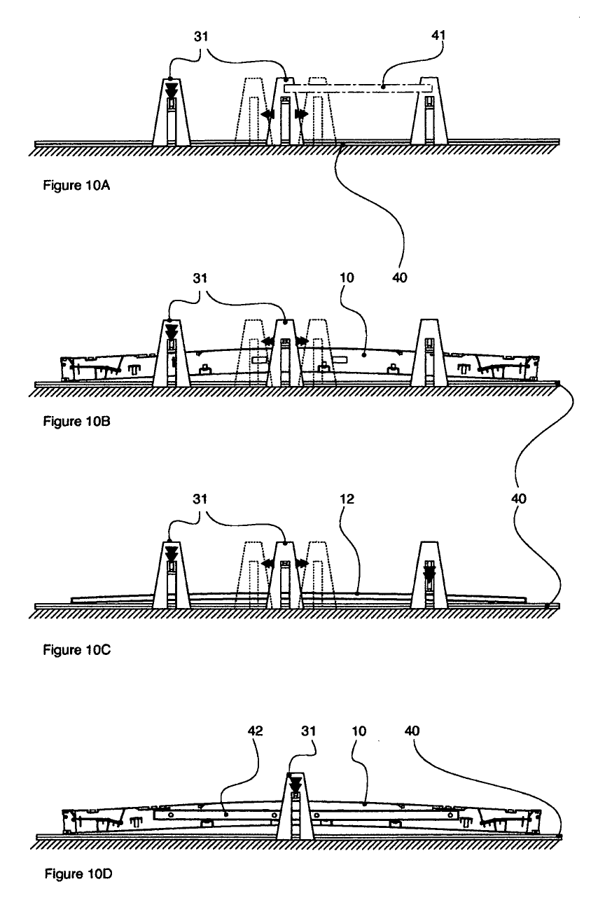

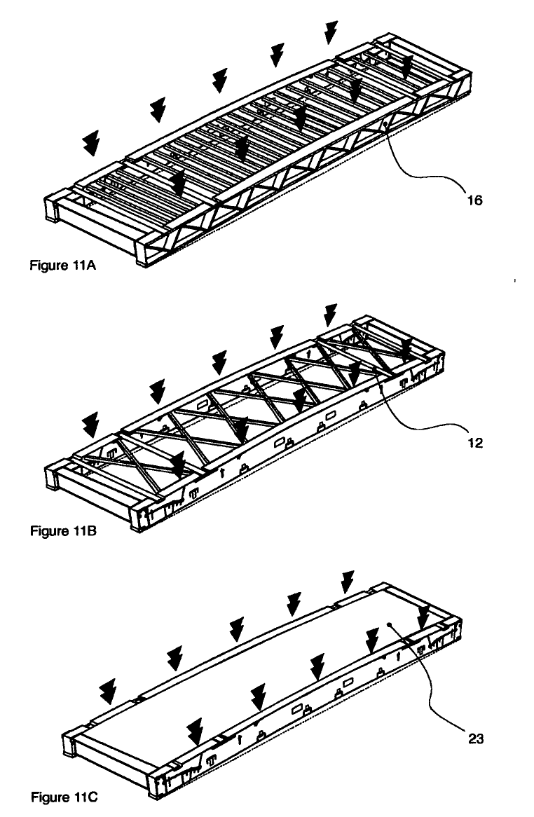

FIGS. 11A through 11C depict pre-loading of diverse configuration deck frame assemblies with variant in fill bracing between opposed longitudinal members;

More specifically . . .

FIG. 11A shows corrugated lattice in-fill bracing 16 to longitudinal side beams;

FIG. 11B shows diagonal cross-beams ** between longitudinal side beams;

FIG. 11C shows a platform deck in-fill between longitudinal side beams; such in-fill could itself be panel subject to pre-loading along with or separately from beam pre-load;

FIGS. 12A through 12D depict variant loading jack formats;

More specifically . . .

FIG. 12A shows a screw pillar jack with offset clamp head to bear upon a workplace;

FIG. 12B shows a screw pillar jack with selectively dis-engageable clamp head;

FIG. 12C shows a hydraulic actuator with offset swivel-mounted clamp head;

FIGS. 13A and 13B depict an open area matrix mounting platform rig for jigs, fixtures clamps, restraints and loading jacks juxtaposed with a subject frame assemblies, in this case of continuous curved closed loop format;

More specifically . . .

FIG. 13A shows a perforated jig bed with jacks disposed about the outer circumference of a frame;

FIG. 13B shows adjustable disposition of a frame upon a mounting platform, with restraint ties ** selectively deployed; thus frame deformation can be curtailed or (re-) directed within the jig;

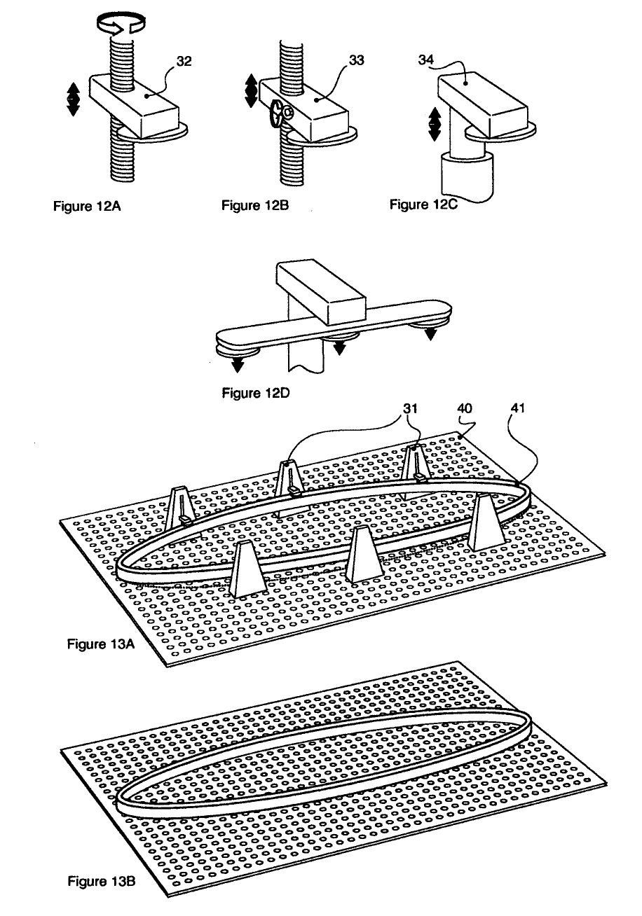

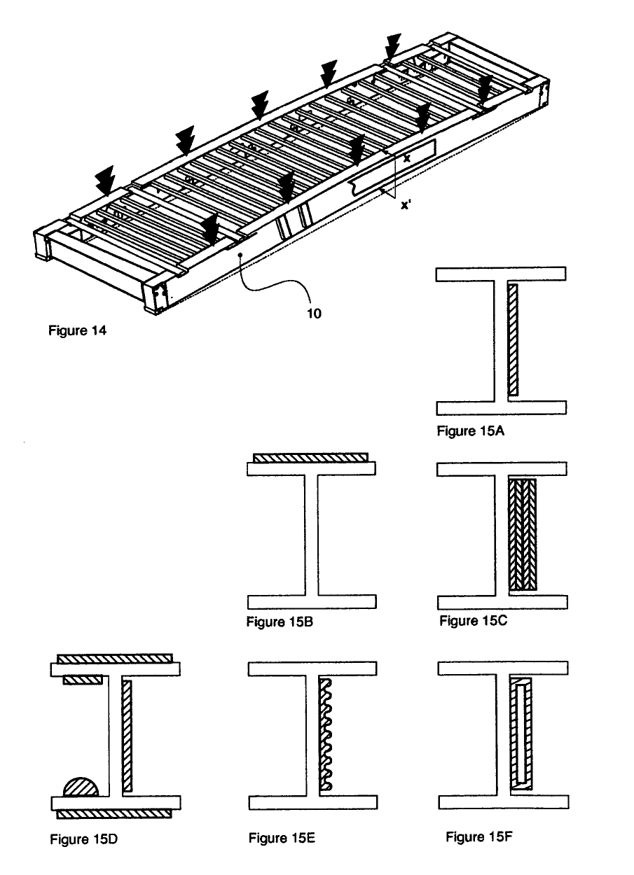

FIGS. 14 and 15A through 15F show pre-loading with local frame bracing by plates and struts, including layered or sandwich disposition;

More specifically . . .

FIG. 14 shows a frame with local bracing elements in longitudinal side frames; variant examples of which are detailed in FIGS. 15A through 15F;

FIG. 15A shows a single sided gusset plate to an I-beam section;

FIG. 15B shows a reinforcement gusset plate upon a top flange;

FIG. 15D shows a stacked web gusset plates;

FIG. 15D shows a diverse cluster of gusset plates inboard and outboard of flanges and webs;

FIG. 15E shows a ribbed gusset plate;

FIG. 15F shows a hollow section gusset element;

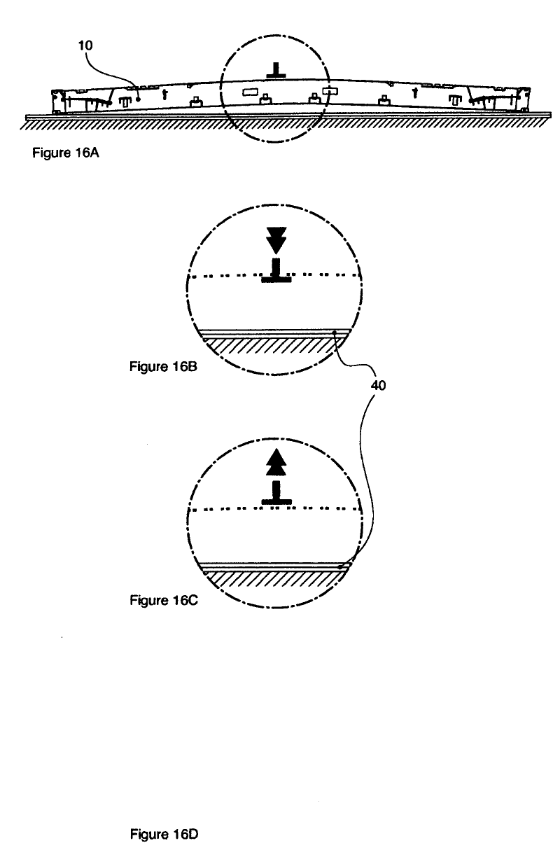

FIGS. 16A through 16D show variable phase loading from continuous to cyclical;

More specifically . . .

FIG. 16A shows a side elevation of a pre-loaded frame

FIG. 16B shows a temporarily increased loading in one direction;

FIG. 16C shows reversed loading from that of FIG. 16B;

FIG. 160 shows reinstated loading in the sense of FIG. 16B;

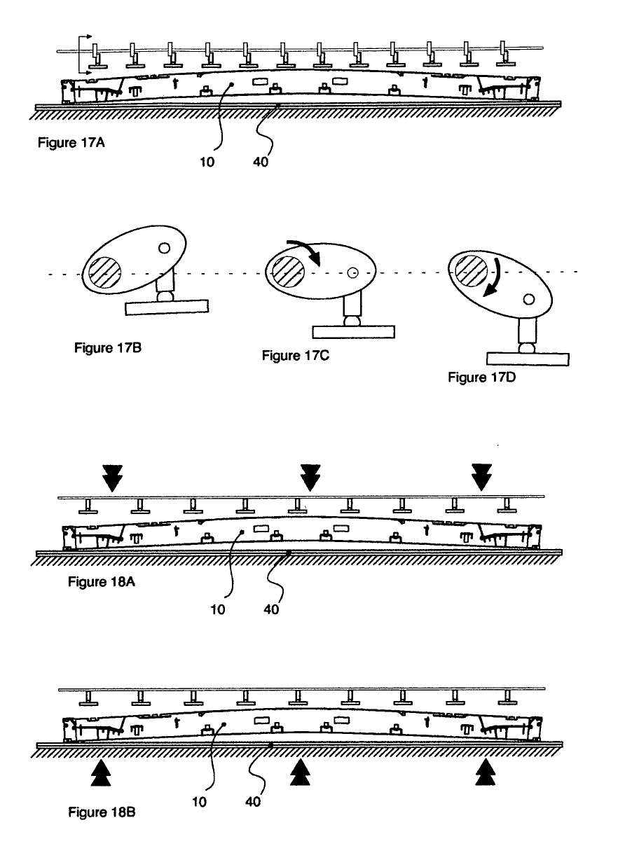

FIGS. 17A through 17D show movable loading jack mounting arrangements;

More specifically . . .

FIG. 17A shows a side elevation of a frame with a juxtaposed overlying loading rig of multiple individual adjustable jacks;

FIG. 17B shows a cross-sectional view of a rotary crank arm mounting of a jack to achieve an eccentric adjustable linear displacement or reciprocatory action;

FIG. 17C shows an intermediate jack displacement;

FIG. 17D shows a more extreme jack displacement;

FIGS. 18A and 18B show a frame loading pattern from one side; using the overhead rig of FIG. 17A;

More specifically . . .

FIG. 18A shows an initial loading phase;

FIG. 18B shows a subsequent loading phase;

FIGS. 19A and 19B show pre-loading between juxtaposed restraint elements fitted outboard of longitudinal deck beams

More specifically . . .

FIG. 19A shows an initial pre-loading stage with an interval between restraints allowing some beam flexing;

FIG. 19B shows beam deflection curtailed by abutment of the restrains;

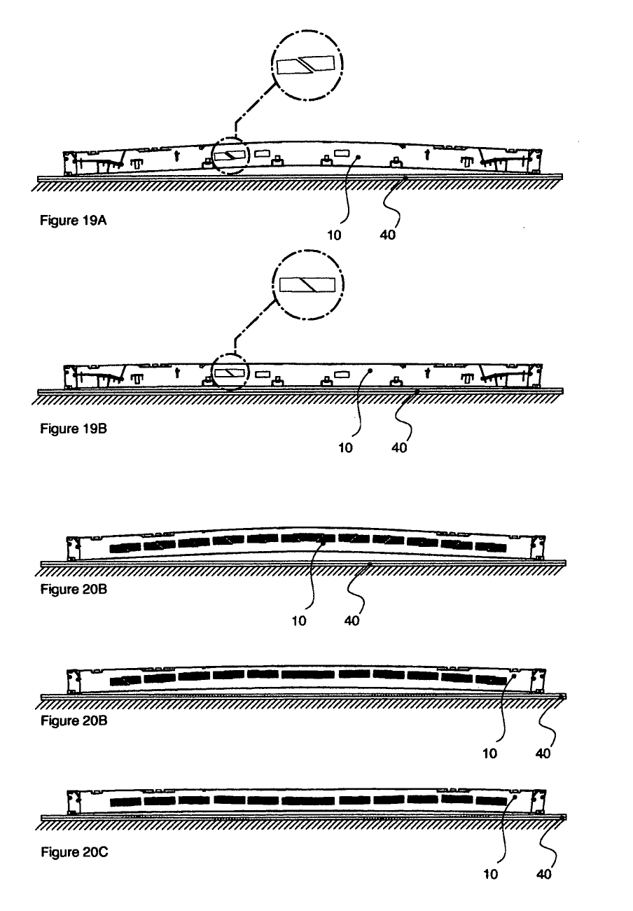

FIGS. 20A through 20C develop the bending restraint proposition of FIGS. 19A and 19B, with repeated restraint element co-operative pairs along the side beams;

More specifically . . .

FIG. 20A shows an interval between all restraints preparatory to initial beam loading and bending deflection;

FIG. 20B shows a reduce interval between some restraints, with others in limiting contact under further beam loading and bending deflection;

FIG. 20C shows limit contact of all restraints under final beam loading and bending deflection;

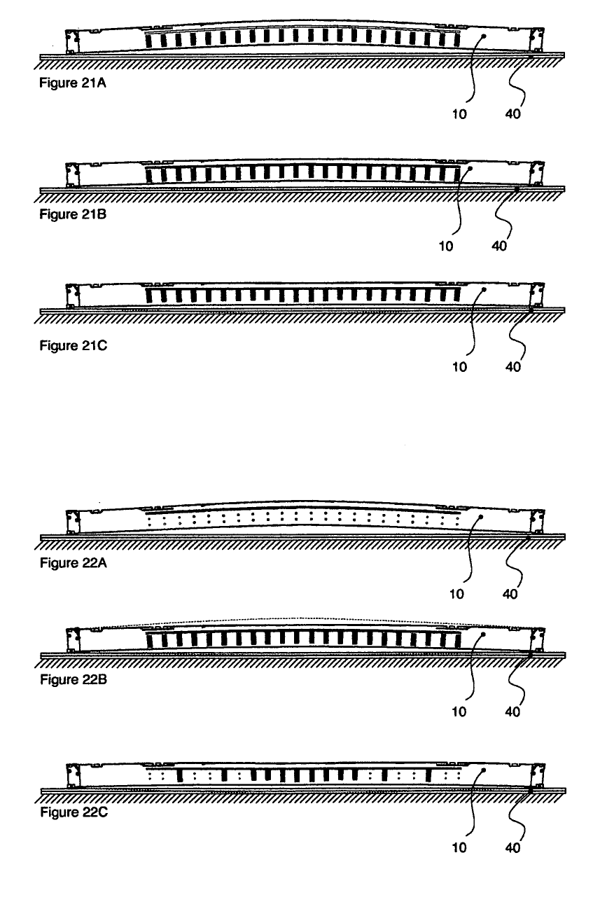

FIGS. 21A through 21C show restraints differently orientated to those of FIGS. 20A through 20C;

More specifically . . .

FIG. 21A shows mutually orthogonal restraint elements disposed along a beam sides for co-operative interaction with a continuous limit bar; in an unloaded condition;

FIG. 21B shows the arrangement of FIG. 21A under initial loading, with some restraint elements at a limit condition in abutment with the common overlying limit bar;

FIG. 21C shows further if not full deflection with most if not all restraints in limiting abutment with the common overlying limit bar;

FIGS. 22A through 22C show yet another restraints disposition to that of FIGS. 20 and 21 sequences;

More specifically . . .

FIG. 22A shows selective installation of restraints along a deck beam in relation to a common juxtaposed overlying (travel) limit bar; this in an unloaded condition;

FIG. 22B shows a variant of FIG. 22A with additional restraints installed;

FIG. 22C shows a variant of FIGS. 22A and 22B with sporadic restraints;

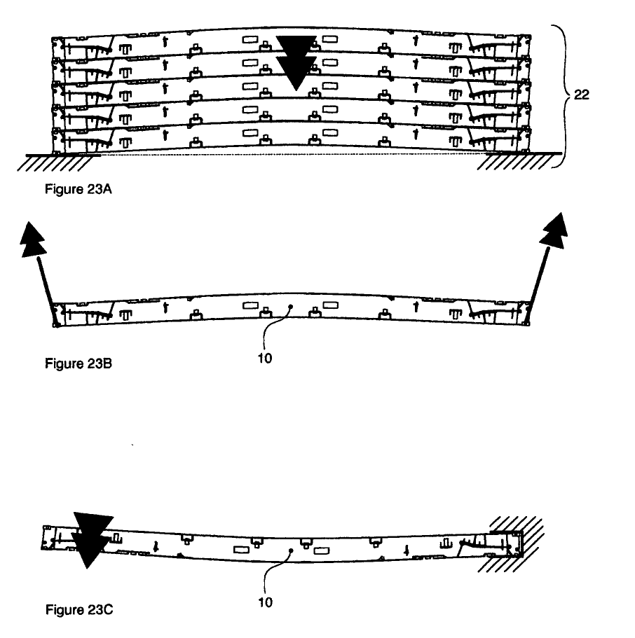

FIGS. 23A through 23C show alternative frame loading and bending arrangements;

More specifically . . .

FIG. 23A shows bending restraint through stacked frames; each frame has an effect upon bending of superimposed underlying and/or overlying frames and thus upon the overall stack deflection;

FIG. 23B shows bending leverage applied from opposite beam ends;

FIG. 23C shows cantilever support from one end with bending from the opposite outboard end;

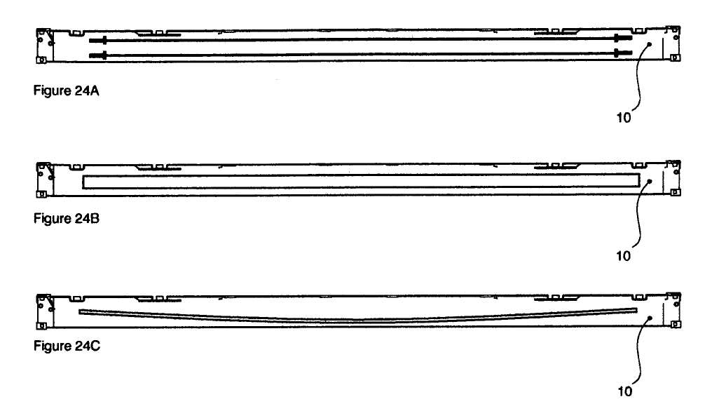

FIGS. 24A through 24C show bending determination through side mounted elements;

More specifically . . .

FIG. 24A shows longitudinal ties alongside a beam, which through which loading could be applied and/or by which loading could be resisted;

FIG. 24B shows a longitudinal side plate applied to a beam for loading restraint;

FIG. 24C shows a pre-formed side bar for loading restraint;

FIGS. 25A and 25B show gross distributed beam loading;

More specifically . . .

FIG. 25A shows a distributed cargo payload sitting upon a pre-loaded beam with counter-curvature;

FIG. 25B shows the beam of FIG. 25A sagging under a cargo load;

Generally, the scale and/or proportion of illustration is for adapted for ease of comprehension and so is not necessarily to scale, or uniform scale, with some judicious local exaggeration (or contraction) introduced where convenient.

Thus fitting a large frame illustration on a modest page span is inherently incompatible with clarity of local detail, so selective focus and distortion is used.

Similarly, some simplification is used for ease of illustration;

Referring to the drawings:

A diversity of frame, frame sub-assembly and pre-loading configurations are depicted by way of example, with a certain self-explanatory simplicity and commonality of form, so not described in detail. Corresponding components are given the same reference. Forces applied are indicated by solid in-fill single-headed arrows.

Generally, a partial or sub-frame assembly 20 is pre-loaded by multiple discrete, but co-ordinated, applied forces to introduce and (re-)distribute internal stresses, preparatory to active working loading in operational use. Thus the frame has a 3-D disposition in space—as do the applied loading vectors. Load forces not immediately braced or countered by a support frame result in frame bending stress.

A minimalist open format perimeter frame is depicted in FIGS. 6A through 7B. A frame with certain in-fill is depicted in FIGS. 1A and 1B. A rectangular format primary perimeter structure comprises opposed longitudinal side beams 10 with cross-beams 11 at opposite ends. This has basic structural integrity along with bending and torsional stiffness, bolstered by intervening intermediate cross-braces 12 and 13.

Local loading 30 is applied by individual actuators 31, such as linear hydraulic or pneumatic jacks as depicted in FIGS. 10A through 10C and are generally represented as bending loads about a point of beam contact in relation to a work-piece counter-brace or support.

For convenience of mounting, multiple jacks depicted in a common mounting bed ** or carriage, with provision for individual jack movement and orientation adjustment. Jacks can be mounted at opposite frame sides, with a work-piece located within the frame embrace. Loading force and travel regulation for individual jacks can also be imposed, along with harmonisation of loading cycles.

A regulator could be fitted to each actuator for ease of setting and adjustment, or reliance placed upon remote control of applied energisation.

Jack and/or beam sensors (not shown) can be used to determine the level of applied force and consequent member movement. A common jack supply source can be harnessed for commonality of, synchronised or phased loading, but each jack can be individually regulated in down or upstroke force and extent of linear travel.

Primarily traditional rectilinear or rectangular cross-section elements, members and assemblies are depicted, such as might be derived from standard (steel) stockholding rolled or extruded profiles, for ease of sourcing and fabrication, but in principle any form could be adopted.

Phased ‘progressive’ loading might be given to more complex or vulnerable member forms, such as hollow round sections, to avoid irredeemable wall kinks or creases. Not all jacks fitted need be activated simultaneously, but rather a pre-programmed loading sequence could be applied.

The jack carriage could be combined upon a bed with a frame support and mounting jig or fixture, to hold frame elements in relative juxtaposition prior to interconnection and/or pre-loading. Automated feed and extraction of frames, co-ordinated with jack deployment, charge and release, could be employed for repetitive tasks.

Pre-loading can be applied between a base plane or support bed and a frame or between frame elements themselves. Temporary bridging elements could be used to span and transfer loads between otherwise remote parts of the frame.

Similarly, supports or braces could be fitted between jacks for additional rigidity in bracing against loading applied to a frame.

With a jack, or opposed jacks, carried upon a frame, some (modest) jack movement relative articulation or spread could be allowed between jacks to follow frame deflection upon applied loading.

Jacks could be carried, say by local clamping in adjustable jaws, between frame elements and allowed to ‘free-float’ to adjust their disposition and orientation according to relative frame deflection. With a double-action internal mechanism, jack loading could reinforce clamping to framework members.

Jacks themselves could be secured together of upon a jack mounting framework in complex dispositions for pre-loading a subject frame sub-assembly. Similarly, for assembling multiple pre-loaded sub-frames jacks could be deployed between them for further pre-load of the larger assembly.

### Component List

10 longitudinal beam
11 end beam
12 cross-brace
13 ribs
14 hinge
15 end wall (folding)
16 corrugated lattice beam
17 hinge
20 sub-assembly
21 frame (sub-)assembly
22 frame stack
23 platform deck
30 pre-load force
31 loading jack
32 screw pillar jack
33 jack clamp arm
34 hydraulic Jack
40 frame support and jack mounting bed
41 curvilinear loop frame

1. A method of pre-loading a sub-frame, preparatory to sub-frame assembly with other pre-loaded or unloaded elements or sub-frames into larger sub-assemblies, culminating with a full or completed frame assembly, along with junctions, links, transitions or joints between elements and/or sub-assemblies, such as flanges or hinges, between elements whereby to introduce and/or retain internal stresses better to accommodate and counter operational loading stress arising.

2. A sub-frame pre-loaded by the method of claim 1.

3. A pre-fabricated container incorporating a pre-loaded sub-frame of claim 2.

4. A collapsible flat-rack configuration container with a platform deck chassis support structure and/or folding end walls pre-loaded by the method of claim 1.

5. A pre-loaded container frame substantially as described in claim 1 with reference to and as shown in the accompanying drawings.

6. A method of manufacturing flatrack base, comprising the following steps:
(a) Fabricate bottom side rails with upward camber.
(b) Fix cross members transversely between two bottom side rails related in step (a) to form a original flatrack base.
(c) Install corner castings on the original flatrack base related in step (b) according to different types of flatracks.
(d) Place the flatrack base related in step (c) on work beds at four corners, and depress the flatrack base by plural cylinders which distributed by the center of bottom side rails on different points.

7. The method of manufacturing flatrack base as set forth in claim 1, wherein the step (c) comprising: firstly weld the corner castings at the bottom of fixed hinge plate, then weld the welded corner castings and fixed hinge plate to the two ends of the sill respectively, finally weld the union of the said three parts to the two ends of the bottom side rails of the original flatrack base.

8. The method of manufacturing flatrack base as set forth in claim 1, wherein the step (c) comprising: weld the corner castings at the bottom of fixed hinge plate, then directly weld the union of welded fixed hinge plate and corner castings at the two sides of the ends of the original flatrack base.

9. The method of manufacturing flatrack base as set forth in claim 2, wherein the base is jacked up at the middle of two longitudinal sides of the flatrack base before implementing the said step (d).

10. The method of manufacturing flatrack base as set forth in claim 4, wherein the said flatrack base is jacked up to make the camber be a 3 mm-5 mm permanent deflection upwards.

11. The method of manufacturing flatrack base as set forth in claim 1, wherein the said bottom side rails are welded rails, comprising top flange, bottom flange and at least one web which is between the top flange and bottom flange, and the web is an arch with camber.

12. The method of manufacturing flatrack base as set forth in claim 6, wherein when the said welded rails are shaped, firstly depress or jack up the top flange and bottom flange to an arched plate which conforms with the camber of web, then separately weld the top flange, bottom flange with the top and bottom of web, so the welded bottom side rails have a certain camber.

13. The method of manufacturing flatrack base as set forth in claim 7, wherein the camber of the web for 40 ft flatrack is 50 mm-80 mm, while the camber of the web for 20 ft flatrack is 15 mm-45 mm.

14. The method of manufacturing flatrack base as set forth in claim 8, wherein depressing the flatrack base on different points in step (d) is finished by several times, the camber of shaped base for 40 ft flatrack is 40 mm-65 mm, while the camber of shaped base for 20 ft flatrack is 10 mm-30 mm.

15. The method of manufacturing flatrack base as set forth in claim 1, wherein the said bottom side rails are hot rolled beams and cambered upwards previously so that the bottom side rails have an upward camber.

16. The method of manufacturing flatrack base as set forth in claim 10, wherein the camber of the bottom side rails for 40 ft flatrack is 50 mm-80 mm, while the camber of the bottom side rails for 20 ft flatrack is 15 mm-45 mm.

17. The method of manufacturing flatrack base as set forth in claim 11, wherein depressing the base on different points in step (d) is finished by several times, the camber of shaped base for 40 ft flatrack is 40 mm-65 mm, while the camber of shaped base for 20 ft flatrack is 10 mm-30 mm.
